(19) United States
(12) Patent Application Publication
(10) Pub. No.: US 2026/0103381 A1
(43) Pub. Date: Apr. 16, 2026

(54) Carbon Nanotube Assembled Wire and Nitrogen-Doped Single-Walled Carbon Nanotube

(71) Applicants: SUMITOMO ELECTRIC INDUSTRIES, LTD., Osaka-shi, Osaka (JP); UNIVERSITY OF TSUKUBA, Tsukuba-shi, Ibaraki (JP)

(72) Inventors: Toshihiko FUJIMORI, Osaka-shi (JP); Hirotaka INOUE, Osaka-shi (JP); Takamasa ONOKI, Osaka-shi (JP); Takeshi Hikata, Osaka-shi (JP); Soichiro OKUBO, Osaka-shi (JP); Jun-ichi FUJITA, Tsukuba-shi (JP)

(73) Assignees: SUMITOMO ELECTRIC INDUSTRIES, LTD., Osaka-shi, Osaka (JP); UNIVERSITY OF TSUKUBA, Tsukuba-shi, Ibaraki (JP)

(21) Appl. No.: 19/143,776

(22) PCT Filed: Jan. 29, 2024
(86) PCT No.: PCT/JP2024/002610

§ 371 Date: Jun. 26, 2025

(30) Foreign Application Priority Data
Jan. 31, 2023 (JP) 2023-013376

(51) Int. Cl. C01B 32/16; B82Y 30/00; B82Y 40/00; C01B 32/159

(52) U.S. Cl. CPC C01B 32/16; C01B 32/159; B82Y 30/00; B82Y 40/00; C01B 2202/02; C01B 2202/06; C01B 2202/22; C01P 2002/85; C01P 2004/03; C01P 2004/04; C01P 2004/133; C01P 2004/16; C01P 2006/40; C01P 2006/60

(57) ABSTRACT

A carbon nanotube assembled wire includes a plurality of carbon nanotubes, wherein the plurality of carbon nanotubes include a plurality of nitrogen-doped single-walled carbon nanotubes, a content ratio of nitrogen in the carbon nanotube assembled wire is 0.5 atomic % or more and 6 atomic % or less, and a content ratio of graphitic nitrogen in the carbon nanotube assembled wire is 0.4 atomic % or more and 3.5 atomic % or less.

### TECHNICAL FIELD

The present disclosure relates to a carbon nanotube assembled wire and a nitrogen-doped single-walled carbon nanotube. The present application claims priority based on Japanese Patent Application No. 2023-013376 filed on Jan. 31, 2023. The entire contents of the Japanese Patent Application are incorporated herein by reference.

### BACKGROUND ART

A carbon nanotube (hereinafter, also referred to as CNT) having a structure in which a graphene sheet in which carbon atoms are bonded in the form of a hexagon is formed into a cylindrical shape is a material having excellent properties, i.e., a material having a weight that is ⅕ of the weight of copper, a strength 20 times as large as the strength of iron steel, and metal-like conductivity. By utilizing the excellent conductivity of the CNT, the CNT is expected to be used as an electrode material or conductive material of an energy device, for example. In order to further improve the conductivity of the CNT, a technique of doping the CNT with nitrogen has been considered.

From the viewpoint of structures, carbon nanotubes can be classified into: a single-walled carbon nanotube with only one carbon wall (graphene) being in the form of a tube; a multi-walled carbon nanotube with a plurality of carbon walls being stacked and in the form of a tube; and the like.

PTL 1 discloses a method of producing a carbon nanotube doped with nitrogen. The nitrogen-doped carbon nanotube produced in PTL 1 is a nitrogen-doped multi-walled carbon nanotube (hereinafter, also referred to as “multi-walled CNT”) having a diameter of 3 to 15 nm.

### CITATION LIST

### Patent Literature

PTL 1: Japanese National Patent Publication No. 2011-506255

### SUMMARY OF INVENTION

A carbon nanotube assembled wire according to the present disclosure is a carbon nanotube assembled wire comprising a plurality of carbon nanotubes, wherein the plurality of carbon nanotubes include a plurality of nitrogen-doped single-walled carbon nanotubes, a content ratio of nitrogen in the carbon nanotube assembled wire is 0.5 atomic % or more and 6 atomic % or less, and a content ratio of graphitic nitrogen in the carbon nanotube assembled wire is 0.4 atomic % or more and 3.5 atomic % or less.

### BRIEF DESCRIPTION OF DRAWINGS

FIG. 1 is a diagram illustrating graphitic nitrogen.

FIG. 2 is a diagram illustrating pyridinic nitrogen.

FIG. 3 shows an exemplary XPS spectrum of a carbon nanotube assembled wire according to a first embodiment.

FIG. 4 is an enlarged view of a range of binding energy of 394 to 406 eV in the XPS spectrum of FIG. 3, and shows a spectrum obtained by separating peaks recognized in the above range.

FIG. 5 is a graph showing a relation between temperature and specific resistance of the carbon nanotube assembled wire.

FIG. 6 is a graph showing an optical absorption spectrum of the carbon nanotube assembled wire.

FIG. 7 is a diagram schematically showing a carbon nanotube production apparatus.

FIG. 8 is a diagram schematically showing a carbon nanotube assembled wire production apparatus.

FIG. 9 shows a transmission electron microscope photograph of a nitrogen-doped single-walled carbon nanotube included in a carbon nanotube assembled wire of a sample 12.

FIG. 10 shows a scanning electron microscope photograph of a cross section of the carbon nanotube assembled wire of sample 12.

FIG. 11 shows a transmission electron microscope photograph of a nitrogen-doped multi-walled carbon nanotube included in a carbon nanotube assembled wire of a sample 1-1.

FIG. 12 shows a content ratio of graphitic nitrogen in each of samples of examples.

FIG. 13 shows a percentage of each of graphitic nitrogen and pyridinic nitrogen in a whole of nitrogen included in the carbon nanotube assembled wire of each of the samples of the examples.

### DETAILED DESCRIPTION

### Problem to be Solved by the Present Disclosure

In recent years, from the viewpoint of sustainable development goals (Sustainable Development Goals: SDGs), improvement in energy efficiency has been required in various fields of technologies. A carbon nanotube having excellent conductivity contributes to improvement in energy efficiency of each of various types of devices using the carbon nanotube.

Thus, an object of the present disclosure is to provide a carbon nanotube and a carbon nanotube assembled wire each having excellent conductivity.

### Advantageous Effect of the Present Disclosure

According to the present disclosure, it is possible to provide a carbon nanotube and a carbon nanotube assembled wire each having excellent conductivity.

### Description of Embodiments

First, embodiments of the present disclosure will be listed and described.

(1) A carbon nanotube assembled wire according to the present disclosure is a carbon nanotube assembled wire comprising a plurality of carbon nanotubes, wherein
the plurality of carbon nanotubes include a plurality of nitrogen-doped single-walled carbon nanotubes,
a content ratio of nitrogen in the carbon nanotube assembled wire is 0.5 atomic % or more and 6 atomic % or less, and
a content ratio of graphitic nitrogen in the carbon nanotube assembled wire is 0.4 atomic % or more and 3.5 atomic % or less.

The carbon nanotube assembled wire according to the present disclosure can have excellent conductivity.

(2) In (1), a content ratio of pyridinic nitrogen in the carbon nanotube assembled wire may be 0.1 atomic % or more and 1.5 atomic % or less. Thus, the conductivity of the carbon nanotube assembled wire is improved.

(3) In (1) or (2), a content ratio of pyridinic nitrogen in the carbon nanotube assembled wire may be 0.3 atomic % or less. Thus, the conductivity of the carbon nanotube assembled wire is improved.

(4) In any one of (1) to (3), the content ratio of the graphitic nitrogen in the carbon nanotube assembled wire may be 0.8 atomic % or more, and
a content ratio of pyridinic nitrogen in the carbon nanotube assembled wire may be 0.3 atomic % or less. Thus, the conductivity of the carbon nanotube assembled wire is improved.

(5) In any one of (1) to (4), a temperature region in which a change ratio of a specific resistance of the carbon nanotube assembled wire is positive may be present at 80 K or more and 300 K or less. Here, the specific resistance is a ratio R2/R1 of a resistance value R2 of the carbon nanotube assembled wire at a measurement temperature to a resistance value R1 of the carbon nanotube assembled wire at 300 K.

Thus, the carbon nanotube assembled wire has a metal-like electrical conduction property at 80 K or more and 300 K or less.

(6) In any of (1) to (5), in an optical absorption spectrum of the carbon nanotube assembled wire, no absorption peak may be present in a range of energy of 0.4 eV or more and 0.7 eV or less. Thus, in the carbon nanotube assembled wire, both a metal-type nitrogen-doped single-walled carbon nanotube and a semiconductor-type nitrogen-doped single-walled carbon nanotube are each expected to function as a conductive path, with the result that it is presumed that the conductivity of the carbon nanotube assembled wire is improved.

(7) In any one of (1) to (6), the plurality of nitrogen-doped single-walled carbon nanotubes consist of a metal-type nitrogen-doped single-walled carbon nanotube and a semiconductor-type nitrogen-doped single-walled carbon nanotube, and
a percentage of the number of the semiconductor-type nitrogen-doped single-walled carbon nanotubes with respect to the total number of the plurality of nitrogen-doped single-walled carbon nanotubes may be 74% or more.

(8) A nitrogen-doped single-walled carbon nanotube according to the present disclosure is a nitrogen-doped single-walled carbon nanotube doped with nitrogen, wherein
a content ratio of nitrogen is 0.5 atomic % or more and 6 atomic % or less, and
a content ratio of graphitic nitrogen is 0.4 atomic % or more and 3.5 atomic % or less.

The nitrogen-doped single-walled carbon nanotube according to the present disclosure can have excellent conductivity.

(9) In (8), a content ratio of pyridinic nitrogen in the nitrogen-doped single-walled carbon nanotube may be 0.1 atomic % or more and 1.5 atomic % or less. Thus, the conductivity of the nitrogen-doped single-walled carbon nanotube is improved.

(10) In (8) or (9), a content ratio of pyridinic nitrogen in the nitrogen-doped single-walled carbon nanotube may be 0.3 atomic % or less. Thus, the conductivity of the nitrogen-doped single-walled carbon nanotube is improved.

(11) In any one of (8) to (10), the content ratio of the graphitic nitrogen in the nitrogen-doped single-walled carbon nanotube may be 0.8 atomic % or more, and
a content ratio of pyridinic nitrogen in the nitrogen-doped single-walled carbon nanotube may be 0.3 atomic % or less.

Thus, the conductivity of the nitrogen-doped single-walled carbon nanotube is improved.

### Details of Embodiments of the Present Disclosure

In order to facilitate understanding of the present disclosure, manners of presence of nitrogen atoms that are doped in a carbon nanotube and that affect a property of the carbon nanotube will be described first.

Depending on the manners of presence of the nitrogen atoms, the nitrogen atoms doped in the carbon nanotube can be classified into graphitic nitrogen (graphitic nitrogen, Graphitic-N), pyridinic nitrogen (pyridinic nitrogen, Pyridinic-N), pyrrolic nitrogen (pyrrolic nitrogen, Pyrrolic-N), and the like.

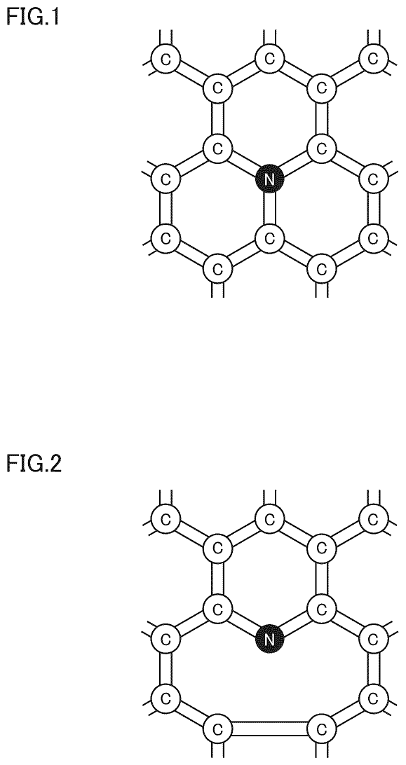

As shown in FIG. 1, in the graphitic nitrogen, one nitrogen atom substitutes for a position of one carbon atom of graphite and is bonded to three carbon atoms. The graphitic nitrogen can improve the conductivity of the carbon nanotube. A carbon nanotube assembled wire including the graphitic nitrogen exhibits a peak at a binding energy of 400.3±0.5 eV in an XPS spectrum measured by X-ray photoelectron spectroscopy (XPS: X-ray Photoelectron Spectroscopy).

As a result of diligent study, the present inventors have doped a single-walled carbon nanotube with a predetermined amount or more of the graphitic nitrogen, thereby completing a nitrogen-doped single-walled carbon nanotube and a carbon nanotube assembled wire each having conductivity much higher than that of a nitrogen-doped multi-walled carbon nanotube.

Specific examples of the nitrogen-doped single-walled carbon nanotube and the carbon nanotube assembled wire according to the present disclosure will be described below with reference to figures. In the figures of the present disclosure, the same reference characters represent the same or corresponding portions. Further, a dimensional relation such as a length, a width, a thickness, or a depth is appropriately changed for clarity and simplification of the figures, and therefore do not necessarily represent an actual dimensional relation.

In the present specification, the expression “A to B” means A or more and B or less, and when no unit is indicated for A and a unit is indicated only for B, the unit of A is the same as the unit of B.

When a compound or the like is expressed by a chemical formula in the present specification and an atomic ratio is not particularly limited, it is assumed that all the conventionally known atomic ratios are included, and the atomic ratio should not be necessarily limited only to one in the stoichiometric range, and all the conventionally known atomic ratios are included.

In the present disclosure, when one or more numerical values are described as each of lower and upper limits of a numerical range, it is assumed that a combination of any one numerical value described as the lower limit and any one numerical value described as the upper limit is also disclosed.

### First Embodiment: Carbon Nanotube Assembled Wire

A carbon nanotube assembled wire according to one embodiment (hereinafter, also referred to as “first embodiment”) of the present disclosure is a carbon nanotube assembled wire including a plurality of carbon nanotubes, wherein the plurality of carbon nanotubes include a plurality of nitrogen-doped single-walled carbon nanotubes, a content ratio of nitrogen in the carbon nanotube assembled wire is 0.5 atomic % or more and 6 atomic % or less, and a content ratio of graphitic nitrogen in the carbon nanotube assembled wire is 0.4 atomic % or more and 3.5 atomic % or less. The carbon nanotube assembled wire according to the first embodiment can have excellent conductivity.

### <Structure of Carbon Nanotube Assembled Wire>

In the carbon nanotube assembled wire according to the first embodiment, the plurality of carbon nanotubes include the plurality of nitrogen-doped single-walled carbon nanotubes. The lower limit of the content ratio of the nitrogen-doped single-walled carbon nanotubes in the carbon nanotube assembled wire according to the first embodiment may be 90 volume % or more, 95 volume % or more, or 98 volume % or more from the viewpoint of improving the conductivity. The upper limit of the content ratio of the nitrogen-doped single-walled carbon nanotubes in the carbon nanotube assembled wire is not particularly limited, and can be 100 volume % or less. The content ratio of the nitrogen-doped single-walled carbon nanotubes in the carbon nanotube assembled wire may be 90 volume % or more and 100 volume % or less, or may be 95 volume % or more and 100 volume % or less.

A method of measuring the content ratio of the nitrogen-doped single-walled carbon nanotubes in the carbon nanotube assembled wire is as follows. For an analysis apparatus, a transmission electron microscope including an energy dispersive X-ray spectrometer is used.

First, the carbon nanotube assembled wire is untangled to prepare a sample in which the plurality of carbon nanotubes included in the carbon nanotube assembled wire are distributed and applied onto a surface of a grid for the transmission electron microscope (preparation step).

Next, the number of walls of each of the carbon nanotubes is observed using the transmission electron microscope so as to specify whether each of the carbon nanotubes is a single-walled carbon nanotube or a multi-walled carbon nanotube (first step).

Next, in the same observation visual field as in the first step, a two-dimensional mapping image of characteristic X-rays originated from nitrogen and carbon is measured using the energy dispersive X-ray spectrometer (second step).

The two-dimensional mapping image of the characteristic X-rays originated from nitrogen and carbon is overlapped with the transmission electron microscope image so as to measure the number (X) of single-walled carbon nanotubes in each of which nitrogen and carbon are detected, the number (Y) of multi-walled carbon nanotubes in each of which nitrogen and carbon are detected, and the number (Z) of single-walled or multi-walled carbon nanotubes in each of which only carbon is detected. The content ratio (volume %) of the nitrogen-doped single-walled carbon nanotubes in the carbon nanotube assembled wire is obtained by calculating {X/(X+Y+Z)}×100 (third step).

### <Content Ratio of Nitrogen of Carbon Nanotube Assembled Wire>

The content ratio of the nitrogen in the carbon nanotube assembled wire according to the first embodiment is 0.5 atomic % or more and 6 atomic % or less. The lower limit of the content ratio of the nitrogen in the carbon nanotube assembled wire may be 0.5 atomic % or more, 0.6 atomic % or more, or 0.7 atomic % or more from the viewpoint of improving the content ratio of the graphitic nitrogen in the carbon nanotube assembled wire. The upper limit of the content ratio of the nitrogen in the carbon nanotube assembled wire is 6 atomic % or less, may be 5.81 atomic % or less, may be 5.13 atomic % or less, may be 3.8 atomic % or less, or may be 3.17 atomic % or less from the viewpoint of the production. The upper limit of the content ratio of the nitrogen in the carbon nanotube assembled wire may be 1.5 atomic % or less or 1.0 atomic % or less from the viewpoint of a ratio of presence of the graphitic nitrogen and the pyridinic nitrogen in the nitrogen. The content ratio of the nitrogen in the carbon nanotube assembled wire is 0.5 atomic % or more and 6 atomic % or less, may be 0.6 atomic % or more and 1.5 atomic % or less, or may be 0.7 atomic % or more and 1.0 atomic % or less.

### <Content Ratio of Graphitic Nitrogen in Carbon Nanotube Assembled Wire>

The content ratio of the graphitic nitrogen in the carbon nanotube assembled wire according to the first embodiment is 0.4 atomic % or more and 3.5 atomic % or less. The lower limit of the content ratio of the graphitic nitrogen in the carbon nanotube assembled wire is 0.4 atomic % or more, may be 0.6 atomic % or more, may be 0.8 atomic % or more, or may be 0.9 atomic % or more from the viewpoint of improving the conductivity. The upper limit of the content ratio of the graphitic nitrogen in the carbon nanotube assembled wire is 3.5 atomic % or less, may be 3.37 atomic % or less, may be 3.18 atomic % or less, may be 2.20 atomic % or less, may be 1.5 atomic % or less, or may be 1.0 atomic % or less from the viewpoint of the production. The content ratio of the graphitic nitrogen in the carbon nanotube assembled wire is 0.4 atomic % or more and 3.5 atomic % or less, may be 0.6 atomic % or more and 3.5 atomic % or less, may be 0.8 atomic % or more and 3.5 atomic % or less, or may be 0.9 atomic % or more and 3.5 atomic % or less.

### <Content Ratio of Pyridinic Nitrogen in Carbon Nanotube Assembled Wire>

As shown in FIG. 2, in the pyridinic nitrogen, one nitrogen atom substitutes for a position of one carbon atom of graphite and is bonded to two carbon atoms. The pyridinic nitrogen tends to decrease the conductivity of the carbon nanotube. The carbon nanotube assembled wire including the pyridinic nitrogen exhibits a peak at a binding energy of 398.5±0.5 eV in the XPS spectrum measured by the X-ray photoelectron spectroscopy (XPS: X-ray Photoelectron Spectroscopy).

The lower limit of the content ratio of the pyridinic nitrogen in the carbon nanotube assembled wire according to the first embodiment may be 0.1 atomic % or more from the viewpoint of the production. The upper limit of the content ratio of the pyridinic nitrogen in the carbon nanotube assembled wire may be 1.5 atomic % or less, 1.16 atomic % or less, 0.99 atomic % or less, 0.87 atomic % or less, 0.67 atomic % or less, 0.65 atomic % or less, 0.45 atomic % or less, 0.3 atomic % or less, 0.25 atomic % or less, 0.2 atomic % or less, or 0.15 atomic % or less from the viewpoint of improving the conductivity. The content ratio of the pyridinic nitrogen in the carbon nanotube assembled wire may be 0.1 atomic % or more and 1.5 atomic % or less, may be 0.1 atomic % or more and 0.65 atomic % or less, may be 0.1 atomic % or more and 0.45 atomic % or less, may be 0.1 atomic % or more and 0.3 atomic % or less, may be 0.1 atomic % or more and 0.25 atomic % or less, may be 0.1 atomic % or more and 0.2 atomic % or less, or may be 0.1 atomic % or more and 0.15 atomic % or less.

Each of the content ratio of the nitrogen, the content ratio of the graphitic nitrogen, and the content ratio of the pyridinic nitrogen in the carbon nanotube assembled wire according to the first embodiment can be measured by X-ray photoelectron spectroscopy. A specific measurement method is as follows.

The carbon nanotube assembled wire is subjected to the X-ray photoelectron spectroscopy under the following conditions so as to obtain the XPS spectrum. For the X-ray photoelectron spectroscopy, “JPS-9010TR” provided by JEOL is used.

### <XPS Conditions>

X-Ray Source: MgKa
Step: 0.1 eV
Number of times of performing scan: 50 times

Based on the obtained XPS spectrum, a peak area A of a peak at a binding energy of 284.5 eV and a peak area B of a peak recognized in a range of binding energy of 394 to 406 eV are measured. Peak area A is originated from the carbon. Peak area B is originated from the nitrogen. The content ratio (atomic %) of the nitrogen in the carbon nanotube assembled wire is obtained by calculating the percentage ([(peak area B/RSF_{N})/((peak area A/RSF_{C})+(peak area B/RSF_{N}))]×100) of (peak area B/RSF_{N}) with respect to the sum of a value (peak area A/RSF_{C}) obtained by dividing peak area A by a relative sensitivity factor (RSF_{C}) of the carbon and a value (peak area B/RSF_{N}) obtained by dividing peak area B by a relative sensitivity factor (RSF_{N}) of the nitrogen. In the present disclosure, the value of [(peak area B/RSF_{N})/((peak area A/RSF_{C})+(peak area B/RSF_{N}))]×100 corresponds to the content ratio (atomic %) of the nitrogen in the carbon nanotube assembled wire.

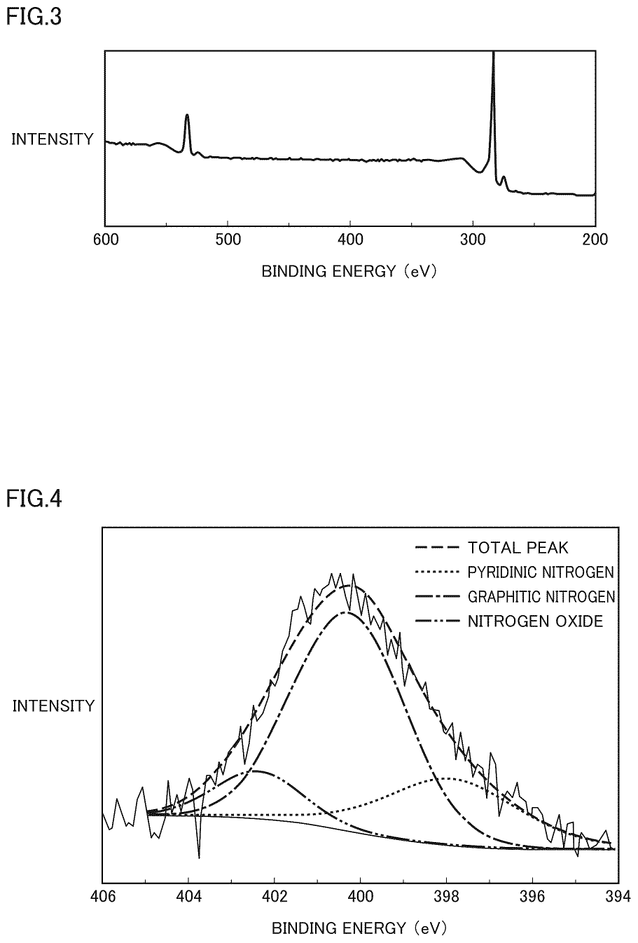

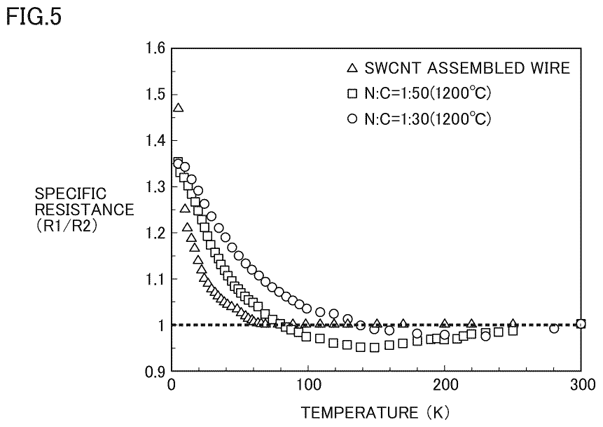

FIG. 3 shows an exemplary XPS spectrum of the carbon nanotube assembled wire according to the first embodiment. FIG. 4 is an enlarged view of the range of binding energy of 394 to 406 eV in the XPS spectrum of FIG. 3, and also shows a spectrum obtained by separating peaks recognized in the above range. In the coordinate system of FIGS. 3 and 4, the X axis represents the binding energy (eV) and the Y axis represents intensity.

In the obtained XPS spectrum, the peaks recognized in the range of binding energy of 394 to 406 eV are separated using a Voigt function. In the spectrum after the peak separation, a peak area C of a peak recognized with a binding energy of 400.3 eV being as the peak top is originated from the graphitic nitrogen, and a peak area D of a peak recognized with a binding energy of 398.5 eV being as the peak top is originated from the pyridinic nitrogen.

A ratio of peak area C to peak area B corresponds to a ratio of the total number of the atoms of the graphitic nitrogen to the total number of the atoms of the nitrogen in the carbon nanotube assembled wire. Therefore, based on the ratio of peak area C to peak area B, the content ratio (atomic %) of the graphitic nitrogen in the carbon nanotube assembled wire can be obtained.

A ratio of peak area D to peak area B corresponds to a ratio of the total number of the atoms of the pyridinic nitrogen to the total number of the atoms of the nitrogen in the carbon nanotube assembled wire. Therefore, based on the ratio of peak area D to peak area B, the content ratio (atomic %) of the pyridinic nitrogen in the carbon nanotube assembled wire can be obtained.

In the carbon nanotube assembled wire according to the first embodiment, the lower limit of a ratio C1/C2 of a content ratio C1 (atomic %) of the graphitic nitrogen and a content ratio (atomic %) C2 of the pyridinic nitrogen may be 1.0 or more, 1.3 or more, 1.5 or more, 2.0 or more, or 2.5 or more. The upper limit of ratio C1/C2 may be 10.0 or less, 5.2 or less, or 5.0 or less. Ratio C1/C2 may be 1.0 or more and 10.0 or less, or may be 2.5 or more and 5.0 or less. Thus, the conductivity of the carbon nanotube assembled wire is improved.

### <Change Ratio of Specific Resistance of Carbon Nanotube Assembled Wire>

In the carbon nanotube assembled wire according to the first embodiment, a temperature region in which a change ratio of a specific resistance of the carbon nanotube assembled wire is positive can be present at 80 K or more and 300 K or less. In the present disclosure, the specific resistance is a ratio R2/R1 of a resistance value R2 of the carbon nanotube assembled wire at a measurement temperature to a resistance value R1 of the carbon nanotube assembled wire at 300 K. For the measurement of the specific resistance, “Model 2182A Nanovoltmeter” provided by Keithley and “Model 6221 AC/DC current source” provided by Keithley are used in combination.

FIG. 5 is a graph showing a relation between the temperature and specific resistance of the carbon nanotube assembled wire. In the coordinate system of FIG. 5, the X axis represents the temperature (K) and the Y axis represents the specific resistance.

In FIG. 5, each of N:C=1:30 (1200° C.) and N:C=1:50 (1200° C.) in explanatory notes indicates the carbon nanotube assembled wire according to the first embodiment. As shown in FIG. 5, the temperature region in which the change ratio of the specific resistance of the carbon nanotube assembled wire is positive at 80 K or more and 300 K or less is present in the carbon nanotube assembled wire according to the first embodiment. This indicates that the carbon nanotube assembled wire according to the first embodiment has a metal-like electrical conduction property at 80 K or more and 300 K or less.

In FIG. 5, a SWCNT assembled wire in the explanatory notes is a carbon nanotube assembled wire consisting of a plurality of single-walled carbon nanotubes each not doped with nitrogen. As shown in FIG. 5, the specific resistance of the carbon nanotube assembled wire consisting of the plurality of single-walled carbon nanotubes each not doped with nitrogen is unchanged at 80 K or more and 300 K or less.

### <Optical Absorption Spectrum of Carbon Nanotube Assembled Wire>

In the optical absorption spectrum of the carbon nanotube assembled wire according to the first embodiment, no absorption peak may be present in a range of energy of 0.4 eV or more and 0.7 eV or less. The optical absorption spectrum was measured using an UV-visible/NIR spectrophotometer V-770 provided by JASCO Corporation.

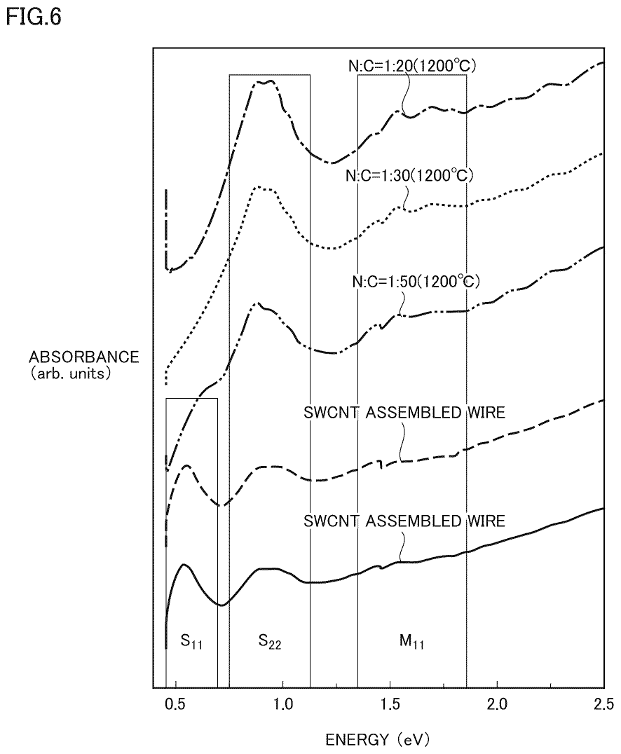

FIG. 6 is a graph showing the optical absorption spectrum of the carbon nanotube assembled wire. In the coordinate system of FIG. 6, the X axis represents the energy (eV) and the Y axis represents absorbance.

In FIG. 6, a SWCNT assembled wire is a carbon nanotube assembled wire consisting of a plurality of single-walled carbon nanotubes each not doped with nitrogen. As the single-walled carbon nanotubes, a metal-type single-walled carbon nanotube and a semiconductor-type single-walled carbon nanotube are present. As shown in FIG. 6, in the optical absorption spectrum of the SWCNT assembled wire, an absorption peak (hereinafter, also referred to as “S11 peak”) in a range of energy of 0.4 eV or more and 0.7 eV or less and an absorption peak (hereinafter, also referred to as “S22 peak”) in a range of energy of 0.7 eV or more and 1.2 eV or less are present. The S11 peak is a peak originated from an S11 band gap of the semiconductor-type single-walled carbon nanotube included in the SWCNT assembled wire. The S22 peak is a peak originated from an S22 band gap of the semiconductor-type single-walled carbon nanotube included in the SWCNT assembled wire. As shown in FIG. 6, in the optical absorption spectrum of the SWCNT assembled wire, an absorption peak (hereinafter, also referred to as “M11 peak”; in FIG. 6, a peak in a range of energy of 1.4 to 1.5 eV and a peak in a range of energy of 1.5 eV to 1.8 eV are present as the M11 peak) is present in a range of energy of 1.3 eV or more and 1.8 eV or less. This indicates that the SWCNT assembled wire includes the metal-type single-walled carbon nanotube. In the SWCNT assembled wire, it is presumed that only the metal-type single-walled carbon nanotube functions as a conductive path.

In FIG. 6, each of N:C=1:20 (1200° C.), N:C=1:30 (1200° C.), and N:C=1:50 (1200° C.) indicates the carbon nanotube assembled wire according to the first embodiment. As shown in FIG. 6, in the optical absorption spectrum of the carbon nanotube assembled wire according to the first embodiment, no absorption peak (S11 peak) in the range of energy of 0.4 eV or more and 0.7 eV or less is present. This indicates that the semiconductor-type nitrogen-doped single-walled carbon nanotube included in the carbon nanotube assembled wire according to the first embodiment is in an electron-doped state. As shown in FIG. 6, in the optical absorption spectrum of the carbon nanotube assembled wire according to the first embodiment, an absorption peak (S22 peak) in a range of energy of 0.7 eV or more and 1.2 eV or less is present. This indicates that the carbon nanotube assembled wire according to the first embodiment includes the semiconductor-type nitrogen-doped single-walled carbon nanotube. Moreover, as shown in FIG. 6, in the optical absorption spectrum of the carbon nanotube assembled wire according to the first embodiment, the absorption peak (M11 peak) in the range of energy of 1.3 eV or more and 1.8 eV or less is present. This indicates that the carbon nanotube assembled wire according to the first embodiment includes the metal-type single-walled carbon nanotube. In the carbon nanotube assembled wire according to the first embodiment, both the metal-type nitrogen-doped single-walled carbon nanotube and the semiconductor-type nitrogen-doped single-walled carbon nanotube in the electron-doped state are each expected to function as a conductive path. Therefore, it is presumed that in the carbon nanotube assembled wire according to the first embodiment, the conductivity is improved as compared with the conventional carbon nanotube assembled wire in which only the metal-type single-walled carbon nanotube functions as a conductive path.

In the carbon nanotube assembled wire according to the first embodiment, the plurality of nitrogen-doped single-walled carbon nanotubes may consist of the metal-type nitrogen-doped single-walled carbon nanotube and the semiconductor-type nitrogen-doped single-walled carbon nanotube, and the percentage of the number of semiconductor-type nitrogen-doped single-walled carbon nanotubes with respect to the total number of the plurality of nitrogen-doped single-walled carbon nanotubes can be 74% or more. The lower limit of the percentage of the number of the semiconductor-type nitrogen-doped single-walled carbon nanotubes with respect to the total number of the plurality of nitrogen-doped single-walled carbon nanotubes may be 78% or more or 79% or more. The upper limit of the percentage of the number of the semiconductor-type nitrogen-doped single-walled carbon nanotubes with respect to the total number of the plurality of nitrogen-doped single-walled carbon nanotubes may be 84% or less or 82% or less from the viewpoint of the production. The percentage of the number of the semiconductor-type nitrogen-doped single-walled carbon nanotubes with respect to the total number of the plurality of nitrogen-doped single-walled carbon nanotubes may be 74% or more and 84% or less, may be 78% or more and 84% or less, or may be 79% or more and 84% or less.

In the carbon nanotube assembled wire according to the first embodiment, the percentage of the number of the semiconductor-type nitrogen-doped single-walled carbon nanotubes with respect to the total number of the plurality of nitrogen-doped single-walled carbon nanotubes can be measured based on the optical absorption spectrum. A specific measurement method is as follows.

The optical absorption spectrum of the carbon nanotube assembled wire is obtained. Based on the obtained optical absorption spectrum, peak area S22 of the absorption peak (S22 peak) in the range of energy of 0.7 eV or more and 1.2 eV or less and peak area M11 of the absorption peak (M11 peak) in the range of energy of 1.3 eV or more and 1.8 eV or less are measured. The percentage of the number of the semiconductor-type nitrogen-doped single-walled carbon nanotubes with respect to the total number of the plurality of nitrogen-doped single-walled carbon nanotubes of the carbon nanotube assembled wire is obtained by calculating the percentage ([peak area S22/(peak area S22+peak area M11)]×100) of peak area S22 with respect to the sum of peak area S22 and peak area M11.

### <Shape of Carbon Nanotube Assembled Wire>

The shape of the carbon nanotube assembled wire according to the first embodiment is not particularly limited, and can be appropriately set in accordance with a purpose of use. The shape of the carbon nanotube assembled wire may be, for example, a shape of yarn in which the plurality of carbon nanotubes are assembled with the plurality of carbon nanotubes being oriented in a long-side direction of each of the plurality of carbon nanotubes.

The length of the carbon nanotube assembled wire according to the first embodiment is not particularly limited, and can be appropriately set depending on a purpose of use. The length of the CNT assembled wire may be, for example, 100 μm or more, 1000 μm or more, or 10 cm or more. The upper limit value of the length of the CNT assembled wire is not particularly limited. From the viewpoint of the production, the length of the CNT assembled wire may be 100 m or less. The length of the CNT assembled wire can be measured by observing it with a scanning electron microscope, an optical microscope, or eyes.

The size of the diameter of the carbon nanotube assembled wire according to the first embodiment is not particularly limited, and can be appropriately set depending on a purpose of use. The diameter of the CNT assembled wire may be, for example, 0.1 μm or more, or 1 μm or more. The upper limit value of the diameter of the CNT assembled wire is not particularly limited, but may be 100 μm or less from the viewpoint of the production. In the first embodiment, the size of the diameter of the CNT assembled wire is smaller than the length of the CNT assembled wire. That is, the length direction of the CNT assembled wire corresponds to the long-side direction thereof.

In the present disclosure, the diameter of the carbon nanotube assembled wire means an average outer diameter of one carbon nanotube assembled wire. A method of measuring the average outer diameter of the one carbon nanotube assembled wire is as follows. At any two positions of the one carbon nanotube assembled wire, the carbon nanotube assembled wire is cut along a plane orthogonal to its long-side direction so as to expose cross sections. Each of the cross sections is observed with a transmission electron microscope or a scanning electron microscope so as to measure the outer diameter, which is a distance between two most distant points on the outer periphery of the carbon nanotube assembled wire in the cross section. The average value of the outer diameters of the two cross sections is calculated. The average value corresponds to the diameter of the carbon nanotube assembled wire.

### <D/G Ratio of Carbon Nanotube Assembled Wire>

In the carbon nanotube assembled wire according to the first embodiment, a D/G ratio may be 0.1 or less, which is a ratio of the peak intensity of a G band and the peak intensity of a D band in Raman spectroscopy at a wavelength of 532 nm.

The G band is a peak originated from the CNT as observed in the vicinity of a Raman shift of 1590 cm⁻¹ in a Raman spectrum obtained by the Raman spectroscopy. The D band is a peak originated from amorphous carbon or a defect of graphite or the CNT as observed in the vicinity of a Raman shift of 1350 cm⁻¹ in the Raman spectrum obtained by the Raman spectroscopy. Hence, it is indicated that as the value of the D/G ratio is smaller, the crystallinity of the carbon nanotube assembled wire is higher and an amount of the amorphous carbon or the graphite having the defect in the carbon nanotube assembled wire is smaller.

When the D/G ratio of the carbon nanotube assembled wire is 0.1 or less, the amorphous carbon and the defect of the graphite are small and the crystallinity is high. Therefore, the carbon nanotube assembled wire can have high tensile strength and high conductivity. The D/G ratio may be 0.1 or less, or 0.01 or less. The lower limit value of the D/G ratio is not particularly limited, and can be, for example, 0 or more. A method of measuring the D/G ratio of the carbon nanotube assembled wire is as follows.

The carbon nanotube assembled wire is subjected to the Raman spectroscopy under the following conditions so as to obtain the Raman spectrum. In the Raman spectrum, the D/G ratio is calculated from the peak intensity of the G band and the peak intensity of the D band.
Measurement Conditions for Raman Spectroscopy
Wavelength: 532 nm
Laser power: 17 mW
Exposure time: 1 second
Average number of times: 3 times
Objective lens magnification: 50 times

### <Method of Producing Carbon Nanotube Assembled Wire>

A method of producing the carbon nanotube assembled wire according to the first embodiment will be described. The carbon nanotube assembled wire according to the first embodiment can include: a step of producing a nitrogen-doped single-walled carbon nanotube; and a step of producing the carbon nanotube assembled wire by assembling a plurality of the nitrogen-doped single-walled carbon nanotubes.

### <<Step of Producing Nitrogen-Doped Single-Walled Carbon Nanotube>>

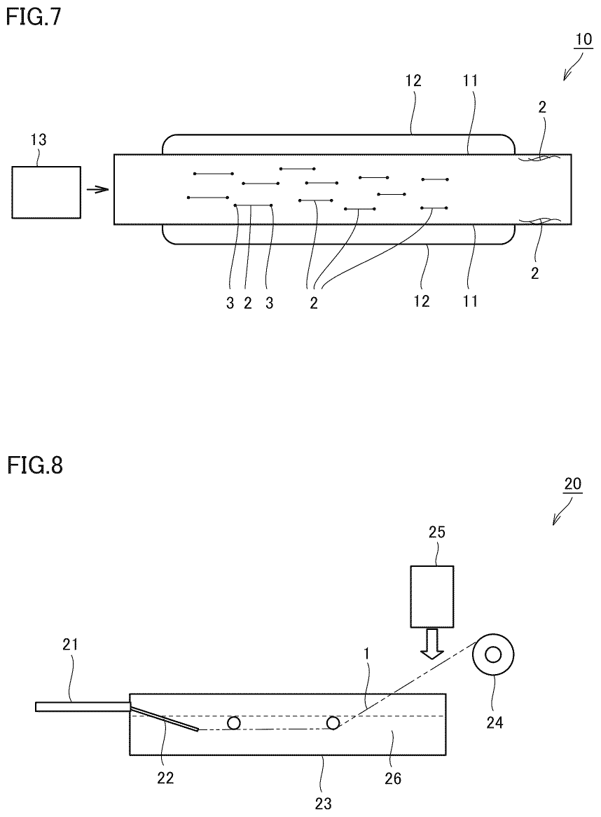

The nitrogen-doped single-walled carbon nanotube can be produced by, for example, a carbon nanotube production apparatus 10 shown in FIG. 7. Carbon nanotube production apparatus 10 can include: a quartz core tube 11; an electric tubular furnace 12 that heats quartz core tube 11; and a source material supply unit 13 that supplies hydrogen and a source material solution into quartz core tube 11 via one end portion of quartz core tube 11.

The source material solution can include ethanol (C₂H₅OH), pyridine (C₅H₅N), ferrocene (Fe(C₅H₅)₂) and thiophene (C₄H₄S). The ethanol is a carbon source. The pyridine is a nitrogen source and a carbon source. The ferrocene is a source of supply of iron (Fe) that is a catalyst. The thiophene is an auxiliary catalyst. A blending ratio of the ethanol and the pyridine in the source material solution can be adjusted to attain a desired ratio of the number of nitrogen atoms and the number of carbon atoms in the source material solution. The content ratio of the ferrocene in the source material solution can be, for example, 0.5 mass %. The content ratio of the thiophene in the source material solution can be, for example, 0.25 mass %.

The source material solution is mixed with the hydrogen supplied to source material supply unit 13, and is sprayed into quartz core tube 11. A rate of sending the source material solution to source material supply unit 13 can be, for example, 0.7 mL/min. The hydrogen is pure hydrogen (concentration of 100%) and is a carrier gas. A flow rate of the hydrogen in quartz core tube 11 is 6 L/min.

A temperature in quartz core tube 11 at the time of synthesis of the nitrogen-doped single-walled carbon nanotubes is 1000° C. or more and 1200° C. or less.

Catalyst (Fe) particles included in the sprayed source material solution float in quartz core tube 11, and the nitrogen-doped single-walled carbon nanotubes are grown from the catalyst particles. The nitrogen-doped single-walled carbon nanotubes are adhered to the inner wall of quartz core tube 11. By collecting the adhered objects, nitrogen-doped single-walled carbon nanotubes 2 can be obtained.

An impurity adhered to each of nitrogen-doped single-walled carbon nanotubes 2 can be removed by performing post-treatment onto the obtained nitrogen-doped single-walled carbon nanotube 2. First, nitrogen-doped single-walled carbon nanotube 2 is heated in dry air at 400° C. for 4 hours. Thus, amorphous carbon adhered to a surface of nitrogen-doped single-walled carbon nanotube 2 and a carbon shell covering a catalyst (Fe) particle 3 adhered to nitrogen-doped single-walled carbon nanotube 2 can be removed.

Next, nitrogen-doped single-walled carbon nanotubes 2 are introduced into 4 mol/L of hydrochloric acid, and is stirred at 80° C. for 24 hours. Thus, the catalyst (Fe) particles adhered to nitrogen-doped single-walled carbon nanotubes 2 can be removed. In a conventional method of producing a nitrogen-doped carbon nanotube, a synthesis temperature is 1000° C. or less, and argon (Ar), nitrogen (N₂), or a mixed gas of argon, nitrogen, and hydrogen is used as a carrier gas. Moreover, even when pure hydrogen is used as the carrier gas, a flow rate of the hydrogen is about 1 L/min. Since the carbon nanotube has multiple walls under such conditions, a single-walled carbon nanotube doped with predetermined amounts or more of nitrogen and graphitic nitrogen cannot be synthesized. As a result of diligent study, the present inventors have found that by setting the synthesis temperature to 1000° C. or more and 1200° C. or less and setting the flow rate of the pure hydrogen serving as the carrier gas to 6 L/min, a nitrogen-doped single-walled carbon nanotube 2 including 0.5 atomic % or more of nitrogen and 0.4 atomic % or more of graphitic nitrogen can be synthesized.

### <<Step of Producing Carbon Nanotube Assembled Wire>>

The carbon nanotube assembled wire can be produced by, for example, a carbon nanotube assembled wire production apparatus 20 shown in FIG. 8. Carbon nanotube assembled wire production apparatus 20 can include a syringe pump 21, a tube 22, a container 23, a bobbin 24, and a dryer 25.

Syringe pump 21 accommodates a slurry. The slurry is a liquid in which the nitrogen-doped single-walled carbon nanotubes are dispersed in chlorosulfonic acid. Syringe pump 21 supplies the slurry to inside of tube 22. An end portion of tube 22 opposite to syringe pump 21 is disposed within container 23.

Container 23 accommodates a coagulation liquid 26. Coagulation liquid 26 is acetone. Bobbin 24 reels the formed carbon nanotube assembled wire. Dryer 25 dries the formed carbon nanotube assembled wire.

The slurry is prepared by introducing the nitrogen-doped single-walled carbon nanotubes into the chlorosulfonic acid and by stirring them at 120° C. for 3 days. A rate of stirring can be 1000 rpm. The content ratio of the nitrogen-doped single-walled carbon nanotubes in the slurry can be 1 mass %.

Next, syringe pump 21 is used to push the slurry into coagulation liquid 26 via tube 22. As a result, the nitrogen-doped single-walled carbon nanotubes included in the slurry are coagulated into a shape of wire, thereby forming the carbon nanotube assembled wire. A rate of pushing the slurry can be 50 μL/min. By adjusting the size of the inner diameter of tube 22, the size of the diameter of the carbon nanotube assembled wire can be set to a desired size. The inner diameter of tube 22 can be, for example, 100 μm or more and 1000 μm or less.

The carbon nanotube assembled wire can be reeled around bobbin 24. A rate of reeling can be 70 cm/min. The carbon nanotube assembled wire can be dried using dryer 25.

According to the method of producing the carbon nanotube assembled wire described above, the length of the carbon nanotube assembled wire can be increased as long as the slurry is continued to be supplied to tube 22.

### Second Embodiment: Nitrogen-Doped Single-Walled Carbon Nanotube

A nitrogen-doped single-walled carbon nanotube according to another embodiment (hereinafter, also be referred to as “second embodiment”) of the present disclosure will be described. The nitrogen-doped single-walled carbon nanotube according to the second embodiment is a nitrogen-doped single-walled carbon nanotube doped with nitrogen, wherein a content ratio of nitrogen is 0.5 atomic % or more and 6 atomic % or less, and a content ratio of graphitic nitrogen is 0.4 atomic % or more and 3.5 atomic % or less. The nitrogen-doped single-walled carbon nanotube according to the second embodiment can have excellent conductivity.

### <Content Ratio of Nitrogen in Nitrogen-Doped Single-Walled Carbon Nanotube>

The content ratio of the nitrogen in the nitrogen-doped single-walled carbon nanotube according to the second embodiment is 0.5 atomic % or more and 6 atomic % or less. The lower limit of the content ratio of the nitrogen in the nitrogen-doped single-walled carbon nanotube is 0.5 atomic % or more, may be 0.6 atomic % or more, or may be 0.7 atomic % or more from the viewpoint of improving the content ratio of the graphitic nitrogen in the nitrogen-doped single-walled carbon nanotube. The upper limit of the content ratio of the nitrogen in the nitrogen-doped single-walled carbon nanotube is 6 atomic % or less, may be 5.81 atomic % or less, may be 5.13 atomic % or less, may be 3.8 atomic % or less, or may be 3.17 atomic % or less from the viewpoint of the production. The upper limit of the content ratio of the nitrogen in the nitrogen-doped single-walled carbon nanotube may be 1.5 atomic % or less or 1.0 atomic % or less from the viewpoint of a ratio of presence of the graphitic nitrogen and the pyridinic nitrogen in the nitrogen. The content ratio of the nitrogen in the nitrogen-doped single-walled carbon nanotube is 0.5 atomic % or more and 6 atomic % or less, may be 0.6 atomic % or more and 1.5 atomic % or less, or may be 0.7 atomic % or more and 1.0 atomic % or less.

### <Content Ratio of Graphitic Nitrogen in Nitrogen-Doped Single-Walled Carbon Nanotube>

The content ratio of the graphitic nitrogen in the nitrogen-doped single-walled carbon nanotube according to the second embodiment is 0.4 atomic % or more and 3.5 atomic % or less. The lower limit of the content ratio of the graphitic nitrogen in the nitrogen-doped single-walled carbon nanotube is 0.4 atomic % or more, may be 0.6 atomic % or more, may be 0.8 atomic % or more, or may be 0.9 atomic % or more from the viewpoint of improving the conductivity. The upper limit of the content ratio of the graphitic nitrogen in the nitrogen-doped single-walled carbon nanotube is 3.5 atomic % or less, may be 3.37 atomic % or less, may be 3.18 atomic % or less, may be 2.20 atomic % or less, may be 1.5 atomic % or less, or may be 1.0 atomic % or less from the viewpoint of the production. The content ratio of the graphitic nitrogen in the nitrogen-doped single-walled carbon nanotube is 0.4 atomic % or more and 3.5 atomic % or less, may be 0.6 atomic % or more and 3.5 atomic % or less, may be 0.8 atomic % or more and 3.5 atomic % or less, or may be 0.9 atomic % or more and 3.5 atomic % or less.

### <Content Ratio of Pyridinic Nitrogen of Nitrogen-Doped Single-Walled Carbon Nanotube>

The lower limit of the content ratio of the pyridinic nitrogen in the nitrogen-doped single-walled carbon nanotube according to the second embodiment may be 0.1 atomic % or more from the viewpoint of the production. The upper limit of the content ratio of the pyridinic nitrogen in the nitrogen-doped single-walled carbon nanotube may be 1.5 atomic % or less, 1.16 atomic % or less, 0.99 atomic % or less, 0.87 atomic % or less, 0.67 atomic % or less, 0.65 atomic % or less, 0.45 atomic % or less, 0.3 atomic % or less, 0.25 atomic % or less, 0.2 atomic % or less, or 0.15 atomic % or less from the viewpoint of improving the conductivity. The content ratio of the pyridinic nitrogen in the nitrogen-doped single-walled carbon nanotube may be 0.1 atomic % or more and 1.5 atomic % or less, 0.1 atomic % or more and 0.65 atomic % or less, 0.1 atomic % or more and 0.45 atomic % or less, 0.1 atomic % or more and 0.3 atomic % or less, 0.1 atomic % or more and 0.25 atomic % or less, 0.1 atomic % or more and 0.2 atomic % or less, or 0.1 atomic % or more and 0.15 atomic % or less.

The nitrogen-doped single-walled carbon nanotube according to the second embodiment may be a nitrogen-doped single-walled carbon nanotube included in the carbon nanotube assembled wire according to the first embodiment. Hereinafter, such an embodiment is also referred to as a second embodiment A.

The nitrogen-doped single-walled carbon nanotube according to the second embodiment may be obtained by untangling the plurality of carbon nanotubes included in the carbon nanotube assembled wire according to the first embodiment and specifying the nitrogen-doped single-walled carbon nanotube by observation with a transmission electron microscope and measurement using an energy dispersive X-ray spectrometer. As the method of specifying the nitrogen-doped single-walled carbon nanotube by the observation with a transmission electron microscope and the measurement using an energy dispersive X-ray spectrometer, the method described in the method of measuring the content ratio of the nitrogen-doped single-walled carbon nanotubes in the carbon nanotube assembled wire described in the first embodiment can be used. Hereinafter, such an embodiment is also referred to as a second embodiment B.

When the nitrogen-doped single-walled carbon nanotube according to the second embodiment is each of second embodiment A and second embodiment B, the content ratio of the nitrogen, the content ratio of the graphitic nitrogen, and the content ratio of the pyridinic nitrogen in the nitrogen-doped single-walled carbon nanotube according to the second embodiment can be regarded as being the same as the content ratio of the nitrogen, the content ratio of the graphitic nitrogen, and the content ratio of the pyridinic nitrogen in the carbon nanotube assembled wire according to the first embodiment, respectively. That is, the content ratio of the nitrogen, the content ratio of the graphitic nitrogen, and the content ratio of the pyridinic nitrogen in the nitrogen-doped single-walled carbon nanotube according to the second embodiment can be obtained by measuring the content ratio of the nitrogen, the content ratio of the graphitic nitrogen, and the content ratio of the pyridinic nitrogen in the carbon nanotube assembled wire according to the first embodiment. This is due to the following reason.

A feature of the method of producing the carbon nanotube assembled wire according to the first embodiment lies in that the source material solution including the nitrogen source and the carbon source is introduced into quartz core tube 11 in a gas phase so as to synthesize the nitrogen-doped single-walled carbon nanotubes.

Nitrogen and carbon simultaneously generated by thermal decomposition are dissolved in the catalyst particles, and then carbon and nitrogen each in a supersaturated state are precipitated from the surfaces of the catalyst particles and are also grown as the nitrogen-doped single-walled carbon nanotubes. In this growth model, the graphitic nitrogen and the pyridinic nitrogen are stochastically introduced into the lattice of each single-walled carbon nanotube. Here, a single-walled carbon nanotube having a diameter of 1 nm and a length of 1 μm is assumed. The number of carbon atoms of this single-walled carbon nanotube is calculated to be about 128,000. When the content ratio of the nitrogen is 1 atomic %, the number of nitrogen atoms contained in the nitrogen-doped single-walled carbon nanotube having the same diameter and the same scale is 1,280, and if the nitrogen is randomly introduced into the lattice of the nitrogen-doped single-walled carbon nanotube, each of the content ratios of the graphitic nitrogen and the pyridinic nitrogen in each nitrogen-doped single-walled carbon nanotube can be approximated with sufficient precision as a statistical average value thereof. Therefore, the content ratio of the nitrogen, the content ratio of the graphitic nitrogen, and the content ratio of the pyridinic nitrogen in the nitrogen-doped single-walled carbon nanotube according to the second embodiment can be regarded as being the same in terms of the statistical average value as the content ratio of the nitrogen, the content ratio of the graphitic nitrogen, and the content ratio of the pyridinic nitrogen in the carbon nanotube assembled wire according to the first embodiment, which is an assembly of a plurality of the nitrogen-doped single-walled carbon nanotubes.

### <Shape of Nitrogen-Doped Single-Walled Carbon Nanotube>

The shape of the nitrogen-doped single-walled carbon nanotube according to the second embodiment is not particularly limited, and a shape having a closed tip or a shape having an open tip can be used. Further, the catalyst used in the production of the carbon nanotube may be adhered to one or both end portions of the carbon nanotube. A cone portion consisting of graphene in the form of a circular cone may be formed at one end portion or each of both end portions of the carbon nanotube.

The length of the nitrogen-doped single-walled carbon nanotube according to the second embodiment can be appropriately selected depending on a purpose of use. The length of the carbon nanotube may be, for example, 10 μm or more, or 100 μm or more. A carbon nanotube having a length of 100 μm or more is suitable from the viewpoint of producing the CNT assembled wire. The upper limit value of the length of the carbon nanotube is not particularly limited, but may be 600 mm or less from the viewpoint of the production. The length of the CNT can be measured by observing it with a scanning electron microscope.

The diameter of the nitrogen-doped single-walled carbon nanotube according to the second embodiment may be 0.6 nm or more and less than 3 nm, or may be 0.6 nm or more and 1.5 nm or less.

In the present specification, the diameter of the carbon nanotube means an average outer diameter of one CNT. The method of measuring the average outer diameter of the CNT is as follows. At any two positions of the CNT, the carbon nanotube is cut along a plane orthogonal to its long-side direction so as to expose cross sections. Each of the cross sections is directly observed with a transmission electron microscope so as to measure a distance L between two most distant points on the outer periphery of the CNT in the cross section. The average value of distances L in the two cross sections is calculated. In the present disclosure, the average value corresponds to the average outer diameter of the carbon nanotube. When the CNT includes the cone portion at one end portion or each of both end portions, the diameter is measured at a location other than the cone portion.

### [Supplementary Note 1]

A nitrogen-doped single-walled carbon nanotube according to the present disclosure is a nitrogen-doped single-walled carbon nanotube included in the carbon nanotube assembled wire according to the first embodiment, wherein
a content ratio of nitrogen is 0.5 atomic % or more and 6 atomic % or less, and
a content ratio of graphitic nitrogen is 0.4 atomic % or more and 3.5 atomic % or less.

### EXAMPLES

The present embodiment will be described more specifically with reference to examples. However, the present embodiment is not limited by these examples.

### [Production of Carbon Nanotube Assembled Wire]

First, carbon nanotubes were produced using carbon nanotube production apparatus 10 shown in FIG. 7.

For each sample, ethanol, pyridine, ferrocene, and thiophene were mixed to prepare a source material solution. A blending ratio of the ethanol and the pyridine in the source material solution was adjusted such that a ratio N:C of the number of nitrogen atoms and the number of carbon atoms in the source material solution was 1:5, 1:10, 1:20, 1:30, or 1:50. The blending ratio of the ethanol and the pyridine in the source material solution of each sample is as shown in the column “N:C Ratio of Numbers of Atoms” in Table 1.

In each of all the samples, the content ratio of the ferrocene in the source material solution was 0.5 mass %, and the content ratio of the thiophene in the source material solution was 0.25 mass %.

The source material solution and the carrier gas were supplied to the source material supply unit, and the source material solution and a carrier gas were sprayed into the quartz furnace core tube. A rate of sending the source material solution to the source material supply unit was 0.7 mL/min.

In each of samples 1 to 15, pure hydrogen (H₂) was used as the carrier gas, and a flow rate of the pure hydrogen in the quartz core tube was 6 L/min.

In a sample 1-1, a mixed gas of argon (Ar) and nitrogen (N₂) was used as the carrier gas, and a flow rate of the mixed gas in the quartz core tube was 1 L/min.

A temperature in the quartz core tube at the time of the synthesis of the carbon nanotubes of each sample is as shown in the column “Synthesis Temperature” of Table 1. With the above steps, the carbon nanotubes were grown from catalyst particles. The carbon nanotubes adhered to the inner wall of the quartz core tube were collected, were heated at 400° C. for 4 hours, were introduced into 4 mol/L of hydrochloric acid, and were stirred at 80° C. for 24 hours. Thus, an impurity adhered to each of the carbon nanotubes was removed.

Next, the obtained carbon nanotubes were used as a source material to produce a carbon nanotube assembled wire of each sample using carbon nanotube assembled wire production apparatus 20 shown in FIG. 8.

The carbon nanotubes were introduced into chlorosulfonic acid and were stirred at 120° C. for 3 days, thereby preparing a slurry. A rate of stirring was 1000 rpm. The content ratio of the carbon nanotubes in the slurry was 1 mass %.

Next, the syringe pump was used to push the slurry into the coagulation liquid via the tube. The coagulation liquid is acetone. Thus, the carbon nanotubes included in the slurry were coagulated into a shape of wire, thereby forming the carbon nanotube assembled wire of each of the samples. A rate of pushing the slurry is 50 μL/min. The inner diameter of the tube is 300 μm.

The carbon nanotube assembled wire was reeled around the bobbin. A rate of reeling is 70 cm/min. The carbon nanotube assembled wire was dried using a dryer.

TABLE 1

| | | Source Material Solution | | | | | |
|---|---|---|---|---|---|---|---|
| | | N:C | | | | Carrier Gas | |
| | | Ratio of | N | C | Synthesis | | Flow |
| Sample | | Numbers | Atomic | Atomic | Temperature | | Rate |
| No. | Notation in Figures | of Atoms | % | % | ° C. | Type | L/min |
| 1 | N:C = 1:5 (1000° C.) | 1:5 | 16.7 | 83.3 | 1000 | H₂ | 6 |
| 2 | N:C = 1:5 (1100° C.) | 1:5 | 16.7 | 83.3 | 1100 | H₂ | 6 |
| 3 | N:C = 1:5 (1200° C.) | 1:5 | 16.7 | 83.3 | 1200 | H₂ | 6 |
| 4 | N:C = 1:10 (1000° C.) | 1:10 | 9.1 | 90.9 | 1000 | H₂ | 6 |
| 5 | N:C = 1:10 (1100° C.) | 1:10 | 9.1 | 90.9 | 1100 | H₂ | 6 |
| 6 | N:C = 1:10 (1200° C.) | 1:10 | 9.1 | 90.9 | 1200 | H₂ | 6 |
| 7 | N:C = 1:20 (1000° C.) | 1:20 | 4.8 | 95.2 | 1000 | H₂ | 6 |
| 8 | N:C = 1:20 (1100° C.) | 1:20 | 4.8 | 95.2 | 1100 | H₂ | 6 |
| 9 | N:C = 1:20 (1200° C.) | 1:20 | 4.8 | 95.2 | 1200 | H₂ | 6 |
| 10 | N:C = 1:30 (1000° C.) | 1:30 | 3.2 | 96.8 | 1000 | H₂ | 6 |
| 11 | N:C = 1:30 (1100° C.) | 1:30 | 3.2 | 96.8 | 1100 | H₂ | 6 |
| 12 | N:C = 1:30 (1200° C.) | 1:30 | 3.2 | 96.8 | 1200 | H₂ | 6 |
| 13 | N:C = 1:50 (1000° C.) | 1:50 | 1.9 | 98.1 | 1000 | H₂ | 6 |
| 14 | N:C = 1:50 (1100° C.) | 1:50 | 1.9 | 98.1 | 1100 | H₂ | 6 |
| 15 | N:C = 1:50 (1200° C.) | 1:50 | 1.9 | 98.1 | 1200 | H₂ | 6 |
| 1-1 | Nitrogen-Doped Multi- | 1:5 | 16.7 | 83.3 | 1000 | Ar, N₂ | 1 |
| | Walled CNT | | | | | | |
| | Assembled Wire | | | | | | |

### [Evaluation of Carbon Nanotube Assembled Wire]

### <Structure of Carbon Nanotube Assembled Wire>

When the carbon nanotube assembled wire of each of samples 1 to 15 was observed by X-ray photoelectron spectroscopy and a transmission electron microscope, it was confirmed that the carbon nanotube assembled wire includes the nitrogen-doped single-walled carbon nanotubes. In Table 2, “Present” is shown in the column “N-SWCN”. It was confirmed that the content ratio of the nitrogen-doped single-walled carbon nanotubes in the carbon nanotube assembled wire of each of samples 1 to 15 is 98 volume %.

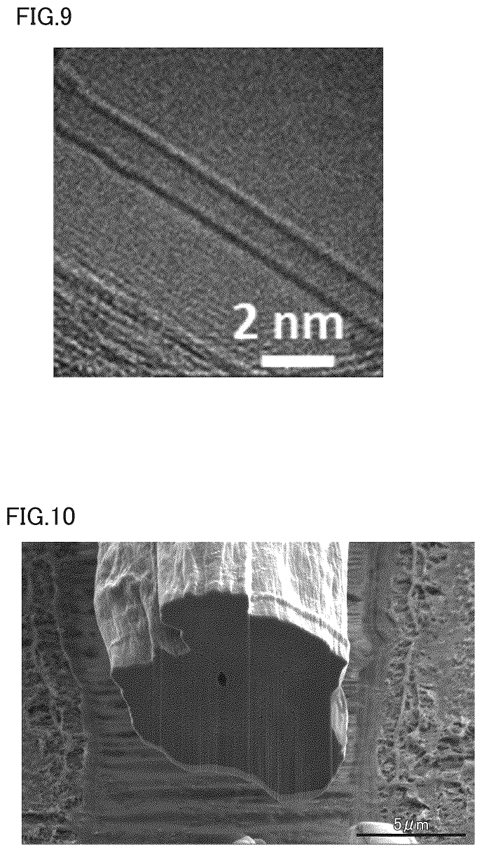

The diameter of the carbon nanotube assembled wire of each of samples 1 to 15 was about 10 μm. FIG. 9 shows a transmission electron microscope photograph of a nitrogen-doped single-walled carbon nanotube of the carbon nanotube assembled wire of sample 12. FIG. 10 shows a scanning electron microscope photograph of a cross section of the carbon nanotube assembled wire of sample 12.

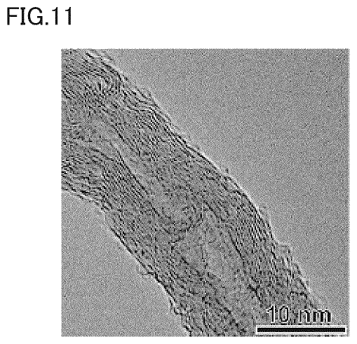

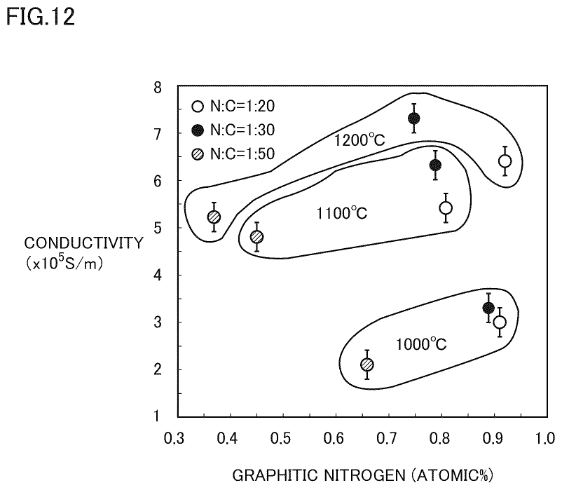

When the carbon nanotube assembled wire of sample 1-1 was observed by X-ray photoelectron spectroscopy and a transmission electron microscope, it was confirmed that the carbon nanotube assembled wire consists of a plurality of multi-walled carbon nanotubes and includes no single-walled carbon nanotube. In Table 2, “Absent” is shown in the column “N-SWCN”. The diameter of the carbon nanotube assembled wire of sample 1-1 was about 10 μm. FIG. 11 shows a transmission electron microscope photograph of a multi-walled carbon nanotube of the carbon nanotube assembled wire of sample 1-1.

### <Content Ratio of Nitrogen, Content Ratio of Graphitic Nitrogen, and Content Ratio of Pyridinic Nitrogen in Carbon Nanotube Assembled Wire>

The content ratio of the nitrogen, the content ratio of the graphitic nitrogen, and the content ratio of the pyridinic nitrogen in the carbon nanotube assembled wire of each of the samples were measured. A specific measurement method is as described in the first embodiment.

The content ratio of the nitrogen in the carbon nanotube assembled wire of each of the samples is shown in the column “Content Ratio of Nitrogen” of the “Carbon Nanotube Assembled Wire” in Table 2.

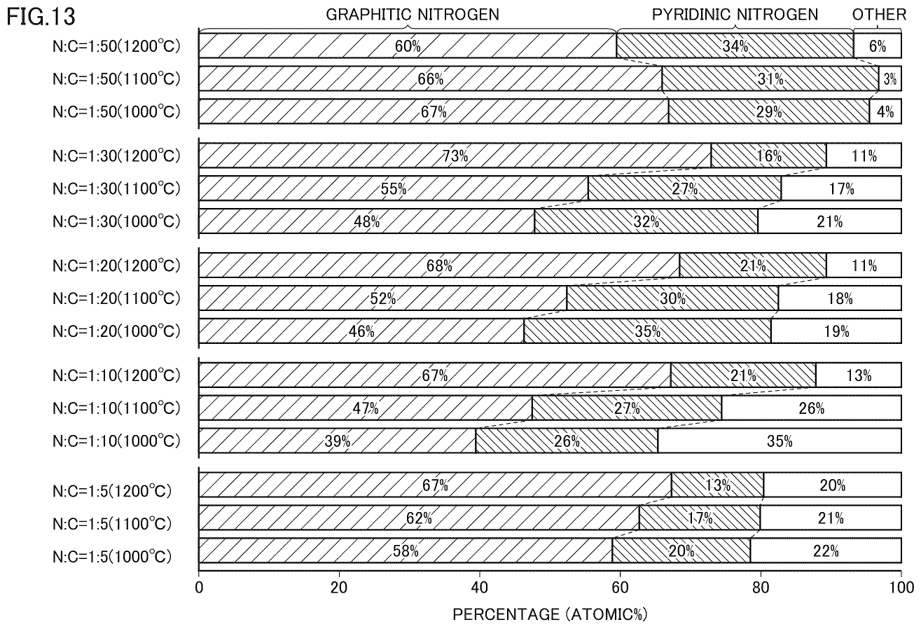

FIG. 13 shows the respective percentages of the graphitic nitrogen and the pyridinic nitrogen in the whole of the nitrogen included in the carbon nanotube assembled wire of each of samples 1 to 15. The content ratio of the graphitic nitrogen and the content ratio of the pyridinic nitrogen included in the carbon nanotube assembled wire of each of the samples are shown in the columns “Content Ratio (C1) of Graphitic Nitrogen” and “Content Ratio (C2) of Pyridinic Nitrogen” of “Carbon Nanotube Assembled Wire” in Table 2. In Table 2, ratio C1/C2 of content ratio C1 of the graphitic nitrogen and content ratio C2 of the pyridinic nitrogen is also shown in “C1/C2”.

### <Percentage of the Number of Semiconductor-Type Nitrogen-Doped Single-Walled Carbon Nanotubes>

In the carbon nanotube assembled wire of each sample, the percentage of the number of the semiconductor-type nitrogen-doped single-walled carbon nanotubes with respect to the total number of the plurality of nitrogen-doped single-walled carbon nanotubes of the carbon nanotube assembled wire was measured. A specific measurement method is as described in the first embodiment. Results are shown in the column “Percentage of Semiconductor-Type” of “Carbon Nanotube Assembled Wire” in Table 2.

### <Change Ratio of Specific Resistance of Carbon Nanotube Assembled Wire>

The specific resistance of the carbon nanotube assembled wire of each of the samples was measured. A specific measurement method is as described in the first embodiment.

In the carbon nanotube assembled wire of each of samples 1 to 15, it was confirmed that the temperature region in which the change ratio of the specific resistance of the carbon nanotube assembled wire is positive at 80 K or more and 300 K or less is present. It was confirmed that in the carbon nanotube assembled wire of sample 1-1, the temperature region in which the change ratio of the specific resistance of the carbon nanotube assembled wire is positive at 80 K or more and 300 K or less is not present. It should be noted that N:C=1:30 (1200° C.) and N:C=1:50 (1200° C.) in FIG. 5 correspond to sample 12 and sample 15, respectively.

### <Optical Absorption Spectrum of Carbon Nanotube Assembled Wire>

The optical absorption spectrum of the carbon nanotube assembled wire of each of the samples was measured. A specific measurement method is as described in the first embodiment.

It was confirmed that in the carbon nanotube assembled wire of each of samples 1 to 15, no absorption peak is present in the range of energy of 0.4 eV or more and 0.7 eV or less. It was confirmed that in the carbon nanotube assembled wire of sample 1-1, the S11 peak, the S22 peak, and the M11 peak, each of which is characteristic to the single-walled carbon nanotube, are not present. It should be noted that N:C=1:20 (1200° C.), N:C=1:30 (1200° C.), and N:C=1:50 (1200° C.) in FIG. 6 correspond to sample 9, sample 12, and sample 15, respectively.

### <Measurement of Conductivity of Carbon Nanotube Assembled Wire>

The conductivity of the carbon nanotube assembled wire of each of the samples was measured. A specific measurement method is as follows. The conductivity of the carbon nanotube assembled wire was measured using a four-terminal method. The length of the carbon nanotube assembled wire was 2 cm, and a distance between voltage terminals was 1 cm. Results are shown in Table 2. Moreover, FIG. 12 shows a relation between the content ratio of the graphitic nitrogen and the conductivity in each of samples 7 to 15. In the coordinate system of FIG. 12, the X axis represents the content ratio (atomic %) of the graphitic nitrogen, and the Y axis represents the conductivity (×105 S/m). In FIG. 12, a sample in a region indicated as 1000° C. indicates that the synthesis temperature is 1000° C., a sample in a region indicated as 1100° C. indicates that the synthesis temperature is 1100° C., and a sample in a region indicated as 1200° C. indicates that the synthesis temperature is 1200° C. For example, a white circle indicated as N:C=1:20 in the region of 1000° C. corresponds to sample 7.

TABLE 2

| | Carbon Nanotube Assembled Wire | | | | | | |
|---|---|---|---|---|---|---|---|
| | | | Content | Content | | | |
| | | | Ratio | Ratio | | | |
| | | Content | (C1) of | (C2) of | | | |
| | | Ratio of | Graphitic | Pyridinic | | Percentage of | |
| | N-SWCN | Nitrogen | Nitrogen | Nitrogen | | Semiconductor- | |
| Sample | Present/ | Atomic | Atomic | Atomic | | Type | Conductivity |
| No. | Absent | % | % | % | C1/C2 | % | 10⁶ S/m |
| 1 | Present | 5.81 | 3.37 | 1.16 | 2.9 | 81 | 0.07 |
| 2 | Present | 5.13 | 3.18 | 0.87 | 3.6 | 78 | 0.11 |
| 3 | Present | 3.28 | 2.20 | 0.43 | 5.2 | 76 | 0.14 |
| 4 | Present | 3.80 | 1.48 | 0.99 | 1.5 | 82 | 0.08 |
| 5 | Present | 3.17 | 1.49 | 0.67 | 2.2 | 77 | 0.09 |
| 6 | Present | 1.60 | 1.07 | 0.34 | 3.2 | 77 | 0.48 |
| 7 | Present | 2.02 | 0.91 | 0.71 | 1.3 | 82 | 0.30 |
| 8 | Present | 1.65 | 0.81 | 0.32 | 2.5 | 84 | 0.54 |
| 9 | Present | 1.35 | 0.92 | 0.28 | 3.3 | 78 | 0.64 |
| 10 | Present | 1.77 | 0.89 | 0.56 | 1.6 | 82 | 0.33 |
| 11 | Present | 1.32 | 0.79 | 0.31 | 2.5 | 82 | 0.63 |
| 12 | Present | 1.01 | 0.75 | 0.16 | 4.7 | 78 | 0.73 |
| 13 | Present | 1.12 | 0.66 | 0.32 | 2.1 | 74 | 0.21 |
| 14 | Present | 0.79 | 0.45 | 0.22 | 2.0 | 79 | 0.48 |
| 15 | Present | 0.54 | 0.37 | 0.09 | 4.1 | 79 | 0.52 |
| 1-1 | Absent | 5.91 | 2.90 | 2.07 | 1.4 | Unable to be | 0.00043 |
| | | | | | | Evaluated | |

### [Review]

The carbon nanotube assembled wires of samples 1 to 15 correspond to examples of the present disclosure. The conductivity of the carbon nanotube assembled wire of each of samples 1 to 15 was 0.07×10⁶ S/m or more (7.0×10⁴ S/m or more). The carbon nanotube assembled wire of sample 1-1 is a comparative example and corresponds to a conventional example. The conductivity of the carbon nanotube assembled wire of sample 1-1 was 0.00043×10⁶ S/m (4.3×10² S/m). It was confirmed that the carbon nanotube assembled wire of each of samples 1 to 15 has conductivity higher by two digits or more than that of the carbon nanotube assembled wire of sample 1-1 of the conventional example.

Although the embodiments and examples of the present disclosure have been described as described above, it is also initially expected to appropriately combine or variously modify the configurations of the above-described embodiments and examples.

The embodiments and examples disclosed herein are illustrative and non-restrictive in any respect. The scope of the present invention is defined by the terms of the claims, rather than the embodiments and examples described above, and is intended to include any modifications within the scope and meaning equivalent to the terms of the claims.

### REFERENCE SIGNS LIST

1 carbon nanotube assembled wire; 2 nitrogen-doped single-walled carbon nanotube; 3 catalyst particle; 10 carbon nanotube production apparatus; 11 quartz furnace core tube; 12 electric tubular furnace; 13 source material supply unit; 20 carbon nanotube assembled wire production apparatus; 21 syringe pump; 22 tube; 23 container; 24 bobbin; 25 dryer; 26 coagulation liquid.

1. A carbon nanotube assembled wire comprising a plurality of carbon nanotubes, wherein
the plurality of carbon nanotubes include a plurality of nitrogen-doped single-walled carbon nanotubes,
a content ratio of nitrogen in the carbon nanotube assembled wire is 0.5 atomic % or more and 6 atomic % or less, and
a content ratio of graphitic nitrogen in the carbon nanotube assembled wire is 0.4 atomic % or more and 3.5 atomic % or less.

2. The carbon nanotube assembled wire according to claim 1, wherein a content ratio of pyridinic nitrogen in the carbon nanotube assembled wire is 0.1 atomic % or more and 1.5 atomic % or less.

3. The carbon nanotube assembled wire according to claim 1, wherein a content ratio of pyridinic nitrogen in the carbon nanotube assembled wire is 0.3 atomic % or less.

4. The carbon nanotube assembled wire according to claim 1, wherein
the content ratio of the graphitic nitrogen in the carbon nanotube assembled wire is 0.8 atomic % or more, and
a content ratio of pyridinic nitrogen in the carbon nanotube assembled wire is 0.3 atomic % or less.

5. The carbon nanotube assembled wire according to claim 1, wherein
a temperature region in which a change ratio of a specific resistance of the carbon nanotube assembled wire is positive is present at 80 K or more and 300 K or less, and
the specific resistance is a ratio R2/R1 of a resistance value R2 of the carbon nanotube assembled wire at a measurement temperature to a resistance value R1 of the carbon nanotube assembled wire at 300 K.

6. The carbon nanotube assembled wire according to claim 1, wherein in an optical absorption spectrum of the carbon nanotube assembled wire, no absorption peak is present in a range of energy of 0.4 eV or more and 0.7 eV or less.

7. The carbon nanotube assembled wire according to claim 1, wherein
the plurality of nitrogen-doped single-walled carbon nanotubes consist of a metal-type nitrogen-doped single-walled carbon nanotube and a semiconductor-type nitrogen-doped single-walled carbon nanotube, and
a percentage of the number of the semiconductor-type nitrogen-doped single-walled carbon nanotubes with respect to the total number of the plurality of nitrogen-doped single-walled carbon nanotubes is 74% or more.

8. A nitrogen-doped single-walled carbon nanotube doped with nitrogen, wherein
a content ratio of nitrogen is 0.5 atomic % or more and 6 atomic % or less, and
a content ratio of graphitic nitrogen is 0.4 atomic % or more and 3.5 atomic % or less.

9. The nitrogen-doped single-walled carbon nanotube according to claim 8, wherein a content ratio of pyridinic nitrogen in the nitrogen-doped single-walled carbon nanotube is 0.1 atomic % or more and 1.5 atomic % or less.

10. The nitrogen-doped single-walled carbon nanotube according to claim 8, wherein a content ratio of pyridinic nitrogen in the nitrogen-doped single-walled carbon nanotube is 0.3 atomic % or less.

11. The nitrogen-doped single-walled carbon nanotube according to claim 8, wherein
the content ratio of the graphitic nitrogen in the nitrogen-doped single-walled carbon nanotube is 0.8 atomic % or more, and
a content ratio of pyridinic nitrogen in the nitrogen-doped single-walled carbon nanotube is 0.3 atomic % or less.
